(19) United States
(12) Patent Application Publication
(10) Pub. No.: US 2019/0360817 A1
(43) Pub. Date: Nov. 28, 2019

(54) Method, Device and System for Localizing a Moving Object

(71) Applicant: Bayerische Motoren Werke Aktiengesellschaft, Muenchen (DE)

(72) Inventors: Maximilian DOEMLING, Shanghai (CN); Sebastian GRANZOW, Kirchheim (DE); Wanli JIANG, Shanghai (CN); Qianshan LI, Shanghai (CN); Rick LI, Shanghai (CN); Bill LV, Shanghai (CN); Ivan XU, Shanghai (CN); Tomas XU, Shanghai (CN)

(21) Appl. No.: 16/533,654

(22) Filed: Aug. 6, 2019

Related U.S. Application Data
(63) Continuation of application No. PCT/CN2017/074672, filed on Feb. 24, 2017.
Application No. PCT/CN2017/074672 is a continuation of application No. PCT/CN2017/073049, filed on Feb. 7, 2017.

(51) Int. Cl. G01C 21/30; G01C 21/36; G06K 9/62; H04W 4/029

(52) U.S. Cl. CPC G01C 21/30; H04W 4/029; G06K 9/6215; G01C 21/3676

(57) ABSTRACT

A method for localization of a moving object includes obtaining a digital map comprising road feature information, receiving position change information of the moving object, and obtaining trace feature information of the moving object by processing the position change information of the moving object. The method further includes determining a localization of the moving object according to similarity between the trace feature information of the moving object and the road feature information.

### CROSS REFERENCE TO RELATED APPLICATIONS

This application is a continuation of PCT International Application No. PCT/CN2017/074672, filed Feb. 24, 2017, which claims priority under 35 U.S.C. §119 from PCT International Application No. PCT/CN2017/073049, filed Feb. 7, 2017, the entire disclosures of which are herein expressly incorporated by reference.

### BACKGROUND AND SUMMARY OF THE INVENTION

The present invention relates to a method for localizing a moving object, especially a vehicle or a robot. Furthermore, the invention also relates to device, system and vehicle for localizing a moving object.

In recent years, a localization system including the Global Navigation Satellite System, GNSS, particularly Global Positioning System (GPS), is often used for obtaining the coordinate of the vehicle in order to determine the localization of the vehicle and finding the corresponding position of the vehicle in the coordinate system in the digital map system.

However, the GPS signal is unable to pass through solid structures so a GPS equipment is unable to work under elevated roads, a bridge or a dense canopy of trees. Especially, when a vehicle with the GPS equipment is moving under the elevated roads, the GPS equipment usually cannot find GPS signal which is not able to pass through the elevated roads above the vehicle with the GPS equipment. The GPS signals can also be affected by multipath issues, where the radio signals reflect off surrounding buildings, walls, hard ground, etc. These reflected signals can cause inaccuracy and delay. Therefore, GPS is typically unreliable in the CBD areas in city center. Furthermore, GPS generally has a positional error of from 2 m to 10 m globally.

An object of the present invention is to avoid the problems caused by the weakness the of the GPS equipment by providing a method and a device for localization of a vehicle or robot on the street which do not always rely on the GPS equipment.

Embodiments of the present invention provide a method, a device, a system and a vehicle for localization the vehicle or robot on the street, which enable a localization for the vehicle without the GPS equipment or at least without continuously utilizing the GPS equipment.

Accordingly, a method for localizing a moving object, especially a vehicle or a robot, is provided, comprising: obtaining, by a data processing device, a digital map, especially a navigation map, comprising road feature information; receiving, by the data processing device, position change information of the moving object; obtaining, by the data processing device, trace feature information of the moving object by processing the position change information of the moving object; and determining, by the data processing device, the localization of the moving object according to similarity between the trace feature information of the moving object and the road feature information.

In a possible implementation manner, the position change information is detected by at least one odometry sensor, or at least one satellite navigation device, especially a GPS localization device, or at least one localization device using cellular signals.

In a further possible implementation manner, the digital map comprises road feature information of road segments.

In another further possible implementation manner, the road feature information comprises: junction angles between two consecutive road segments; and/or length of each road segments; and/or curvature of each road segments.

In another further possible implementation manner, the step “receiving, by the data processing device, position change information of the moving object from a device for detecting change in position” comprises: receiving, by the data processing device, the position change information of the moving object from the device for detecting change in position over a first time period.

In another further possible implementation manner, the step c) “obtaining, by the data processing device, trace feature information of the moving object by processing the position change information of the moving object” comprises: segmenting the trace of the moving object into trace segments; and obtaining trace feature information for each trace segment.

In another further possible implementation manner, the trace feature information comprises at least: junction angles between two consecutive trace segments, and/or lengths of each trace segments, and/or curvatures of the each segments.

In another further possible implementation manner, the step “determining, by the data processing device, the localization of the moving object according to similarity between the trace feature information of the moving object and the road feature information” comprises: choosing at least one matching road segment for each trace segment according to similarity between the road feature information of the matching road segment and the trace feature information of the corresponding trace segment; choosing at least one set of consecutive matching road segments using the similarity between the road feature information of the matching road segment and the trace feature information of the trace of the moving object according to the maximum likelihood estimation; and determining the localization of the moving object according to the localization of the chosen at least one set of consecutive matching road segments in the digital map.

In another further possible implementation manner, the method further comprises: determining, by the data processing device, whether the localization of the moving object should be determined further.

In another further possible implementation manner, if the localization of the moving object should be determined further, the method further comprises: receiving, by the data processing device, further position change information of the moving object; obtaining, by the data processing device, trace feature information of the moving object by processing the position change information and the further position change information; and determining, by the data processing device, the localization of the moving object by matching the road feature information with the position change information and the further position change information.

According to a further aspect, a data processing device for localizing a moving object, especially a vehicle or a robot, is provided, wherein the data processing device is adapted to: obtain a digital map, especially a navigation digital map, comprising road feature information; receive position change information of the moving object from a device for detecting change in position; obtain trace feature information of the moving object by processing the position change information of the moving object; and determine the localization of the moving object according to similarity between the trace feature information of the moving object and the road feature information.

In a possible implementation manner, the device for detecting change in position comprises: at least one odometry sensor; or at least one satellite navigation device, especially GPS localization device; or at least one localization device using cellular signals.

In further possible implementation manner, the digital map comprises road feature information of road segments.

In another further possible implementation manner, the road feature information comprises at least: junction angles between two consecutive road segments; and/or lengths of the road segments; and/or curvatures of the road segments.

In another further possible implementation manner, the data processing device is further adapted to receive the position change information of the moving object from the device for detecting change in position over a first time period.

In another further possible implementation manner, the data processing device is further adapted to: segment the trace of the moving object into trace segments; and obtain trace feature information for each trace segment.

In another further possible implementation manner, the trace feature information comprises at least: junction angles between two consecutive trace segments; and/or lengths of the trace segments; and/or curvatures of the trace segments.

In another further possible implementation manner, the data processing device is further adapted to: choose at least one matching road segment for each trace segment according to similarity between the road feature information of the matching road segment and the trace feature information of the corresponding trace segment; choose at least one set of consecutive matching road segments using the similarity between the road feature information of the matching road segment and the trace feature information of the trace of the moving object according to the maximum likelihood estimation; and determine the localization of the moving object according to the localization of the chosen at least one set of consecutive matching road segments in the digital map.

In another further possible implementation manner, the data processing device is further adapted to: determine, whether the localization of the moving object should be determined further.

In another further possible implementation manner, the data processing device is further adapted to: receive further position change information of the moving object; obtain trace feature information of the moving object by processing the position change information and the further position change information; and determine the localization of the moving object by matching the road feature information with the position change information and the further position change information.

According to a further aspect, a system comprising a data processing device mentioned above and at least one device for detecting position change is provided.

In a possible implementation manner, the device for detecting position change comprises at least one odometry sensor.

In a further possible implementation manner, the device for detecting position change comprises at least one satellite navigation device, especially a GPS localization device.

In another further possible implementation manner, the device for detecting position change comprises at least one localization device using cellular signals.

According to another further aspect, a vehicle or a robot comprising a system mentioned above is provided.

In the embodiments of the present invention, the method or the data processing device for localization of a vehicle may obtain road/street information from a digital navigation digital map and receive an position change information, i.e. the trace of the vehicle from sensor e.g. odometry sensor. After calculating the trace feature information of the position change information detected by the odometry sensor, the method searches the matching roads in the digital map for the trace of the vehicle by comparing the road feature information and the trace feature information. Then the method can find the consecutive roads in the digital map which have the maximum similarity with the trace of the vehicle. Therefore, the localization of the vehicle can be determined according to the localization of the end of the roads in the digital map, which have the maximum similarity with the trace of the vehicle. Thus, a method for localization is provided, which enables an initial localization for the vehicle without the GPS equipment, at least without continuously utilizing GPS, and the problems caused by the weakness of GPS can be avoided.

To describe the technical solutions in the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows an example of a part of digital map comprising a plurality of roads.

FIG. 2 shows an example of a trace of the vehicle.

FIG. 3 is a schematic diagram of an embodiment of the method according to the present invention.

FIG. 4 shows a schematic diagram of an embodiment of the data processing device according to the present invention.

### DETAILED DESCRIPTION OF THE DRAWINGS

The following clearly and completely describes the technical solutions in the embodiments of the present invention with reference to the accompanying drawings in the embodiments of the present invention. Apparently, the described embodiments are some but not all of the embodiments of the present invention. All other embodiments obtained by a person of ordinary skill in the art based on the embodiments of the present invention without creative efforts shall fall within the protection scope of the present invention.

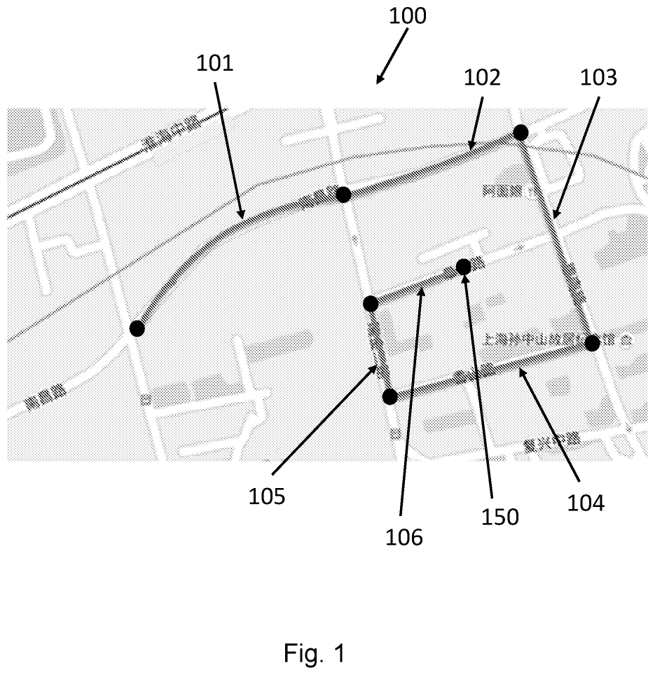

FIG. 1 illustrates a part of a digital map 100 showing a plurality of roads. The plurality of roads comprise roads segments 101, 102, 103, 104, 105 and 106. A road segment can be segmented from a long road according to the characteristic features of the road segment, e.g. the curvature of the road segment, the length of the road segment and the junction angle between the road segment and a consecutive road segment of the road segment.

Normally, the curvature of the road segment can be calculated by using the information about the shape of the road provided by the digital map. The length of the road segment can be normally directly obtained from the navigation map system. Furthermore, the junction angle between a first road segment and a second road segment connected to the first road segment can be calculated based on the information provided by the navigation map system, e.g. HERE Map system, TomTom navigation map and Google Map etc.

Normally the digital map system uses a geographic information system, GIS, file format which is a standard of encoding geographical information into a computer file. GIS data represents real objects (such as roads, land use, elevation, trees, waterways, etc.) with digital data determining the mix. Traditionally, there are two broad methods used to store data in a GIS for both kinds of abstractions mapping references: raster images and vector. In a digital map, geographical features are often expressed as vectors, by considering those features as geometrical shapes. Different geographical features are expressed by different types of geometry: Points, lines, and polygons.

Points are used for geographical features that can best be expressed by a single point reference, e.g. wells, peaks, features of interest, and trailheads. Points convey the least amount of information of these file types. One-dimensional lines or polylines are used for linear features such as roads, railroads, trails, rivers, and topographic lines. Again, as with point features, linear features displayed at a small scale will be represented as linear features rather than as a polygon. Line features can measure distance. Two-dimensional polygons are used for geographical features that cover a particular area of the earth's surface. Such features may include lakes, park boundaries, buildings, city boundaries, or land uses. Polygons convey the most amount of information of the file types. Polygon features can also measure perimeter and area.

Each of these geometries are linked to a row in a database that describes their attributes. For example, a database that describes lakes may contain a lake's depth, water quality, pollution level. This information can be used to make a map to describe a particular attribute of the dataset. Different geometries can also be compared. Vector features can be made to respect spatial integrity through the application of topology rules such as ‘polygons must not overlap’. Vector data can also be used to represent continuously varying phenomena. Contour lines and triangulated irregular networks (TIN) are used to represent continuously changing values. Vector data allows for visually smooth and easy implementation of overlay operations, especially in terms of graphics and shape-driven information like maps, routes and custom fonts.

The digital map can be pre-stored in a map data base of the on board navigation system in the vehicle and can be called by computer implemented program.

Roads segments such as 101, 102, 103, 104, 105 and 106 in FIG. 1 connect to each other at positions like crosses, forks in the roads or other traffic elements.

The roads segments can be segmented by traffic elements such as crosses or folks in the roads. They can also be segmented according to the curvature of the road segments. For example, the road segments 101 and 102 have different curvatures and can be segmented according to value of their curvatures. More specifically, the road segment 101 is a curve road and has a higher curvature than that of road segment 102 which is more a straight road.

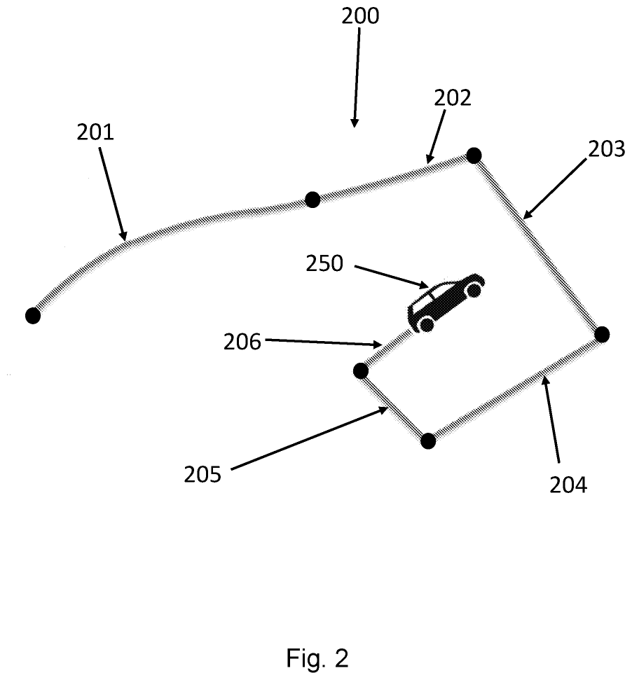

FIG. 2 shows a trace 200 of a moving vehicle 250. Clearly the vehicle 250 has traveled along the route, i.e. the trace 200 comprising the trace segments 201, 202, 203, 204, 205 and 206. The trace 200 can be detected by an odometry sensor. Alternatively, the trace 200 can also be detected by GPS equipment or one localization device using cellular signals.

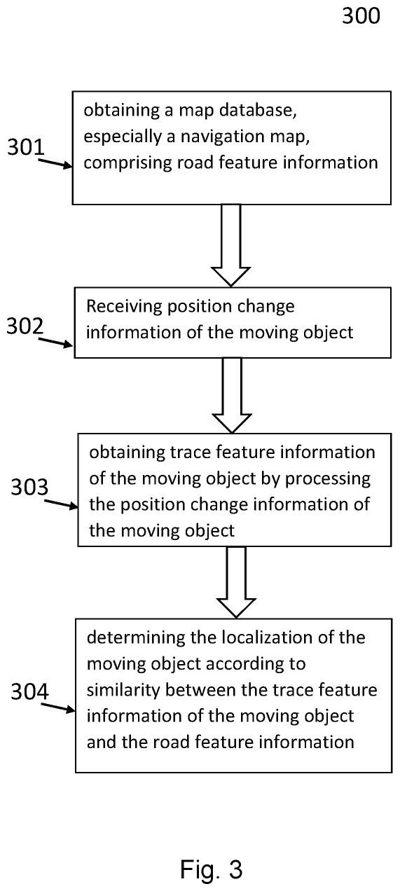

FIG. 3 shows a schematic diagram of an embodiment of the method for localization of a moving object, especially a vehicle or a robot. The method can be implemented by a data processing device, e.g. a processor with corresponding computer program.

Firstly, the digital map, especially a navigation map, which comprises road feature information of all roads and road segments in the digital map (including the road segments 101, 102, 103, 104, 105 and 106) can be obtained from e.g. the onboard navigation system in the vehicle. The road feature information includes junction angles between two consecutive road segments e.g. junction angles between the road segments 102 and 103, length of each road segments 101, 102, 103, 104, 105 and 106, and the curvature (or the average curvature) of each road segments.

The roads are segmented by elements such as crosses or folks in the roads. They can also be segmented according to the curvature of the road segments. For example, the road segment 101 is a curve road and has a higher curvature than that of road segment 102 which is more a straight road. Since the road segments 101 and 102 have different curvatures, they can be segmented according to different value of the curvatures.

Secondly, the method receives position change information, more specifically a trace of the vehicle. The trace of vehicle can be detected by an odometry sensor in the vehicle, GPS equipment or a localization device using cellular signals during a time period t1. The time period t1 can be predetermined. The trace records the route the vehicle traveled along during the time period t1.

Then, the trace feature information including junction angles between two consecutive trace segments e.g. junction angles between the trace segments 202 and 203, lengths of each trace segments 201, 202, 203, 204, 205 and 206 and curvatures of the each trace segments of the vehicle can be obtained by segmenting the trace of the vehicle into the trace segments 201, 202, 203, 204, 205 and 206 and furthermore calculating the trace feature information for each trace segment 201, 202, 203, 204, 205 and 206.

After obtaining both of road feature information of all road segments in the digital map (including the road segments 101, 102, 103, 104, 105 and 106) and the trace feature information of the trace segments 201, 202, 203, 204, 205 and 206 of the trace the vehicle traveled along during a time period t1, the localization of the vehicle can be determined according to similarity between the trace feature information of the trace segments 201, 202, 203, 204, 205 and 206 and the road feature information of the road segments in the digital map.

More specifically, the method chooses at least one first matching road segment for the first trace segment 201 according to similarity of the road feature information of the road segment in the digital map and the trace feature information of the trace segment 201. In this case, the method can choose the road segment 101, at least as one of the first matching road segments, for the first trace segment 201, because the road feature information of the road segment 101 has a very high similarity with that of the trace segment 201. In a similar way, the road segments 102, 103, 104, 105 and 106 can be chosen as candidate matching road segments for the trace segments 202, 203, 204, 205 and 206 respectively.

Moreover, if the set of consecutive matching road segments 201, 202, 203, 204, 205 and 206 has the highest similarity with the trace segments 101, 102, 103, 104, 105 and 106, the consecutive road segments 201, 202, 203, 204, 205 and 206 in the digital map can be chosen as the matching road for the trace of the vehicle in the time period t1 according to the maximum likelihood estimation theory. Therefore, the localization of the vehicle can determined according to the localization of the end point 150 of the matching road segments 201, 202, 203, 204, 205 and 206 in the digital map.

In case that a lot of sets of consecutive road segments in the digital map are same or very similar with the trace segments, the localization of the vehicle should be determined further until a set of consecutive road segments having the highest similarity in view of the trace segments can be found.

If the method for determining localization should be executed further, the method receives further position change information of the vehicle, i.e. a further trace during a time period t2. The time period t2 can be predetermined. Then, the method obtains trace feature information of the trace of the time period t1 and the time period t2. Then, the localization of the vehicle can be determined by matching the road feature information of the road segments in the digital map with the trace of the time period t1 and the time period t2. Such a process can be executed continuously until a set of consecutive matching road segments having a highest similarity is found.

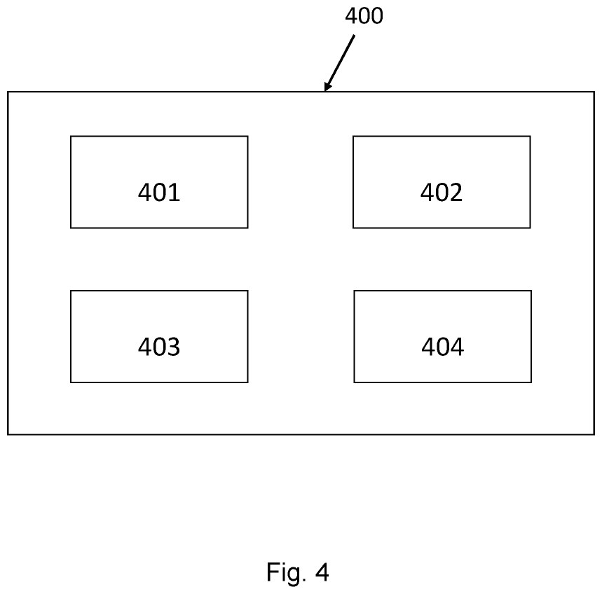

FIG. 4 shows a schematic diagram of the data processing device 400 according to the present invention. The data processing device 400 can be implemented in a vehicle or a robot.

The data processing device 400 can implement the above-mentioned method for determining localization. The data processing device is adapted to: obtain a digital map, especially a navigation map, comprising road feature information; receive position change information of the moving object from a device for detecting change in position; obtain trace feature information of the moving object by processing the position change information of the moving object; and determine the localization of the moving object according to similarity between the trace feature information of the moving object and the road feature information.

More specifically, the data processing device comprises a digital map obtaining module 401 which is adapted to obtain a digital map, especially a navigation map, comprising road feature information, a trace receiving module 402 which is adapted to receive position change information of the moving object from a device for detecting change in position, a trace feature information calculation module 403 which is adapted to calculate/obtain trace feature information of the moving object by processing the position change information of the moving object, and the localization determining module 404 which is adapted to determine the localization of the moving object according to similarity between the trace feature information of the moving object and the road feature information.

The digital map comprises road feature information of road segments comprising at least one of the following characters: junction angles between two consecutive road segments; lengths of the road segments; and curvatures of the road segments. Correspondingly, the trace feature information comprises at least one of the following characters: junction angles between two consecutive road segments; lengths of the road segments; and curvatures of the road segments.

The trace feature information calculation module 403 is further adapted to segment the trace of the moving object into trace segments, and obtain trace feature information for each trace segment. The trace feature information including junction angles between two consecutive trace segments e.g. junction angles between the trace segments 202 and 203, lengths of each trace segments 201, 202, 203, 204, 205 and 206 and curvatures of the each trace segments of the vehicle can be obtained by segmenting the trace of the vehicle into the trace segments 201, 202, 203, 204, 205 and 206 and then calculating the trace feature information for each trace segment 201, 202, 203, 204, 205 and 206.

After obtaining both of road feature information of all road segments in the digital map and the trace feature information of the trace segments 201, 202, 203, 204, 205 and 206 of the trace the vehicle traveled along during a time period t1, the localization of the vehicle can be determined according to similarity between the trace feature information of the trace segments 201, 202, 203, 204, 205 and 206 and the road feature information of the road segments in the digital map.

The localization determining module 404 is further adapted to choose at least one matching road segment for each trace segment according to similarity between the road feature information of the matching road segment and the trace feature information of the corresponding trace segment; choose at least one set of consecutive matching road segments using the similarity between the road feature information of the matching road segment and the trace feature information of the trace of the moving object according to the maximum likelihood estimation; and determine the localization of the moving object according to the localization of the chosen at least one set of consecutive matching road segments in the digital map.

Accordingly, the localization determining module 404 chooses at least one first matching road segment for the first trace segment 201 according to similarity of the road feature information of the road segment in the digital map and the trace feature information of the trace segment 201. In this case, the road segment 101 can be chosen as one of the first matching road segments, for the first trace segment 201, if the road feature information of the road segment 101 has the highest similarity (or one of the road segments which have a relative high similarity) with that of the trace segment 201. In a similar way, the road segments 102, 103, 104, 105 and 106 can be chosen as candidate matching road segments for the trace segments 202, 203, 204, 205 and 206 respectively.

Therefore, if the set of consecutive matching road segments 201, 202, 203, 204, 205 and 206 has the highest similarity with the trace segments 101, 102, 103, 104, 105 and 106, the consecutive road segments 201, 202, 203, 204, 205 and 206 in the digital map can be chosen as the matching road for the trace of the vehicle during the time period t1 according to the maximum likelihood estimation theory. Therefore, the localization of the vehicle can determined according to the localization of the end point 150 of the matching road segments 201, 202, 203, 204, 205 and 206 in the digital map.

If the data processing device finds a lot of sets of consecutive road segments in the digital map are same or very similar with the trace segments, the localization of the moving object should be determined further until a set of consecutive road segments having the highest similarity in view of the trace segments can be found. In this case, the data processing device receives further position change information of the vehicle during a further time period t2; obtain trace feature information by processing the position change information and the further position change information; and determine the localization by matching the road feature information with the trace feature information according to the time period t1 and the trace feature information according to the further time period t2.

The device for detecting change in position can be e.g. an odometry sensor. Alternatively, it can also comprise a GPS localization device or a localization device using cellular signals. The localization device using cellular signals measures the distances between the vehicle and at least three base stations of mobile communication by using the cellular signals of the base stations respectively, and calculates the localization of the vehicle by using the distances to the base stations.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for localization of a moving object, the method comprising:
obtaining, by a data processing device, a digital map comprising road feature information
receiving, by the data processing device, position change information of the moving object;
obtaining, by the data processing device, trace feature information of the moving object by processing the position change information of the moving object; and
determining, by the data processing device, a localization of the moving object according to similarity between the trace feature information of the moving object and the road feature information.

2. The method according to claim 1, wherein the position change information is detected by:
at least one odometry sensor;
at least one satellite navigation device; or
at least one localization device using cellular signals.

3. The method according to claim 1, wherein the digital map comprises road feature information of a plurality of road segments.

4. The method according to claim 3, wherein the road feature information comprises:
junction angles between two consecutive road segments of the plurality of road segments;
a length of each of the plurality of road segments; and/or
a curvature of each of the plurality of road segments.

5. The method according to claim 1, wherein receiving, by the data processing device, position change information of the moving object comprises receiving, by the data processing device, the position change information of the moving object from the device for detecting change in position over a first time period.

6. The method according to claim 1, wherein obtaining, by the data processing device, trace feature information of the moving object by processing the position change information of the moving object comprises:
segmenting a trace of the moving object into trace segments and
obtaining the trace feature information for each of said trace segments.

7. The method according to claim 6, wherein the trace feature information comprises:
junction angles between two consecutive ones of the trace segments;
a length of each of the trace segments; and/or
a curvature of each of the trace segments.

8. The method according to claim 6, wherein determining, by the data processing device, the localization of the moving object according to similarity between the trace feature information of the moving object and the road feature information comprises:
choosing at least one matching road segment for each of the trace segments according to similarity between the road feature information of the matching road segment and the trace feature information of a corresponding one of the trace segments;
choosing at least one set of consecutive matching road segments using the similarity between the road feature information of the matching road segment and the trace feature information of the trace of the moving object according to the maximum likelihood estimation; and
determining the localization of the moving object according to a localization of the chosen at least one set of consecutive matching road segments in the digital map.

9. The method according to claim 1, wherein the method further comprises determining, by the data processing device, whether the localization of the moving object should be determined further.

10. The method according to claim 9, wherein if the localization of the moving object should be determined further, the method further comprises:
receiving, by the data processing device, further position change information of the moving object;
obtaining, by the data processing device, trace feature information of the moving object by processing the position change information and the further position change information; and
determining, by the data processing device, the localization of the moving object by matching the road feature information with the position change information and the further position change information.

11. A data processing device configured for localization of a moving object, wherein the data processing device is configured to:
obtain a digital map comprising road feature information;
receive position change information of the moving object from a device configured to detect change in position;
obtain trace feature information of the moving object by processing the position change information of the moving object; and
determine a localization of the moving object according to similarity between the trace feature information of the moving object and the road feature information.

12. The data processing device according to claim 11, wherein the device configured to detect change in position comprises:
at least one odometry sensor;
at least one satellite navigation device; or
at least one localization device using cellular signals.

13. The data processing device according to claim 11, wherein the digital map comprises road feature information of a plurality of road segments.

14. The data processing device according to claim 13, wherein the road feature information comprises:
junction angles between two consecutive road segments of the plurality of road segments;
a length of each of the plurality of road segment; and/or
a curvature of each of the plurality of road segments.

15. The data processing device according to claim 11, wherein the data processing device is further configured to receive the position change information of the moving object from the device configured to detect change in position over a first time period.

16. The data processing device according to claim 11, wherein the data processing device is further configured to:
segment a trace of the moving object into trace segments; and
obtain the trace feature information for each of said trace segments.

17. The data processing device according to claim 16, wherein the trace feature information comprises:
junction angles between two consecutive ones of the trace segments;
a length of each of the trace segments; and/or
a curvature of each of the trace segments.

18. The data processing device according to claim 16, wherein the data processing device is further configured to:
choose at least one matching road segment for each trace segment according to similarity between the road feature information of the matching road segment and the trace feature information of a corresponding one of the trace segments;
choose at least one set of consecutive matching road segments using the similarity between the road feature information of the matching road segment and the trace feature information of the trace of the moving object according to the maximum likelihood estimation; and
determine the localization of the moving object according to a localization of the chosen at least one set of consecutive matching road segments in the digital map.

19. The data processing device according to claim 11, wherein the data processing device is further configured to determine, whether the localization of the moving object should be determined further.

20. The data processing device according to claim 11, wherein the data processing device is further configured to:
receive further position change information of the moving object;
obtain trace feature information of the moving object by processing the position change information and the further position change information; and
determine the localization of the moving object by matching the road feature information with the position change information and the further position change information.
